(19) United States
(12) Patent Application Publication
(10) Pub. No.: US 2009/0112796 A1
(43) Pub. Date: Apr. 30, 2009

(54) Natural language conceptual joins

(76) Inventor: Marvin Elder, Carrollton, TX (US)

Correspondence Address: STEVEN THRASHER, 391 SANDHILL DRIVE, RICHARDSON, TX, 75080, US

(21) Appl. No.: 12/004,601

(22) Filed: Dec. 21, 2007

Related U.S. Application Data
(63) Continuation-in-part of application No. 11/923,164, filed on Oct. 24, 2007.

(51) Int. Cl. G06F 7/06

(52) U.S. Cl. 707/2; 707/E17.015

(57) ABSTRACT

The invention answers a user's information request, stated in the user's natural language, by dynamically retrieving and merging facts and information from disparate and possibly geographically dispersed databases and presenting a single answer to the user. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATION

The invention is related to and claims priority from pending U.S. Provisional Patent Application No. 11/923,164 to Elder, et al., entitled NATURAL LANGUAGE DATABASE QUERYING filed on 20 Aug. 2004 which is incorporated by reference herein in its entirety.

### TECHNICAL FIELD OF THE INVENTION

The present invention relates generally structured data querying, and more particularly to natural language database querying.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Database querying is limited to accessing a single database at a time. Therefore, there exists the need for methods of accessing, retrieving and merging information from multiple disparate databases in a single information request.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is a graphic illustration of a semantified iStack for a Hospital-based Healthcare Company.

FIG. 2 is an exemplary relational block diagram of a cohesive intelligence system.

FIG. 3a illustrates an exemplary round-trip sequence of events occurring in a single natural language request collected from disparate databases.

FIG. 3b is a block-flow diagram of the method discussed in FIG. 3a.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Computing platforms are computers, such as personal computers, workstations, servers, or sub-systems of any of the aforementioned devices. Further, a computing platform may be segmented by functionality into a first computing platform, second computing platform, etc. such that the physical hardware for the first and second computing platforms is identical (or shared), where the distinction between the devices (or systems and/or sub-systems, depending on context) is defined by the separate functionality which is typically implemented through different code (software).

Of course, the foregoing discussions and definitions are provided for clarification purposes and are not limiting. Words and phrases are to be given their ordinary plain meaning unless indicated otherwise.

### DESCRIPTION OF THE DRAWINGS

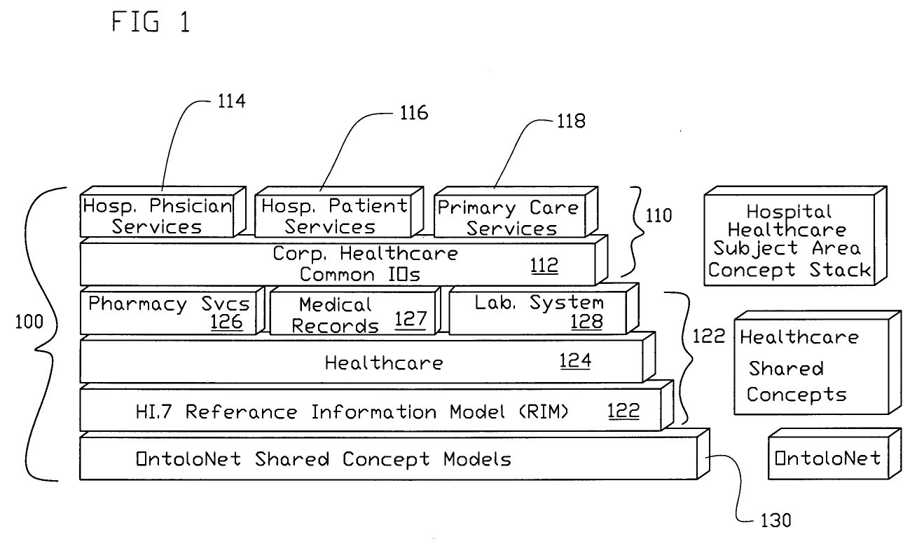

Natural Language Database Querying (NLDQ) defines a base functionality of current embodiment, is summarized as:
a) The NL Request is submitted to a Natural Language Understanding (NLU) module, which interprets the meaning of the user's NL Request as a set of semantic objects within a taxonomy of ontologies,
b) These semantic objects are transformed into mirrored concept objects within the taxonomy,
c) The mirrored concept objects are mapped through inferencing to “top-level” concept objects within the taxonomy,
d) The top-level concept objects are mapped to actual database schema objects of a target relational database,
e) A database query command is generated in Structured Query Language (SQL),
f) The database query is executed against one targeted database or against a federated database of several databases housed on a common server,
   The result set of this query is captured, formatted and returned to the user. This process is better understood in conjunction with a description of an exemplary ontology. Accordingly, FIG. 1 is a graphic illustration of a semantified iStack for a Hospital-based Healthcare Company.

### Semantification of Target Data Source Schema

In NLDQ, each targeted single database or federated database has undergone an initial “semantification process”, whereby the database schema elements of the targeted database are captured in a repository, along with a mapped set of “conceptual objects” that are captured as a “top-level” (“specific”) ontology.

Part of the semantification process is to “type” each concept object in the top-level ontology to a “parent” concept object in an ontology that is more general than the new specific ontology (through a hypernymy relationship). When this semantification step is completed, the new top-level ontology forms its own taxonomy, called an “intelligence stack” (iStack).

In FIG. 1, there are three ontologies in the iStack: 1) the client's specific Hospital-based Healthcare ontology (Hospital specific ontology 110), 2) a general Healthcare ontology that includes the industry standard ontology (General Healthcare ontology 120, comprising structures such as the Healthcare Information Model (HL7)), and 3) a set of most-general “shared” concept model objects 130 (“OntoloNet”).

The hospital specific ontology 110 comprises data maintained in separate but federated databases such as Hospital Physician Services 112, Hospital Patient Database 116 and Primary Care Services 119, and includes a database housing tables of common information objects (113??) shared by the federated specific databases. The general healthcare ontology 120 comprises more-general concepts and/or data, including pharmacy services 126 (concepts only), medical records 127 (concepts and data), lab system 128 (concepts only) and a industry-sponsored reference information model 122 (concepts only). The hospital specific ontology concepts are types of general healthcare specific ontology concepts, which in turn are types of more abstract concepts defined in the OntoloNet 130.

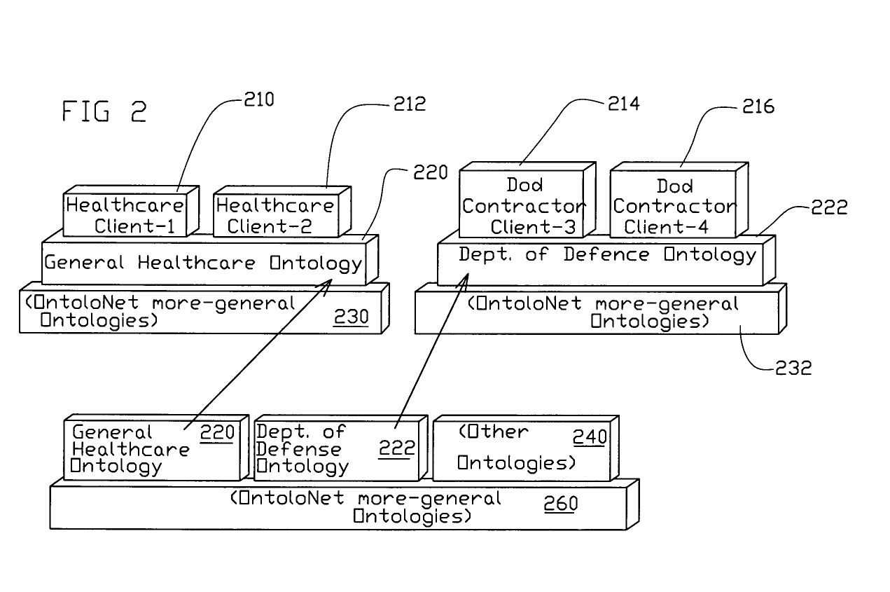

Next, an embodiment of the NLDQ which demonstrates that exact answers can be extracted from multiple disparate databases, housed on different servers, from a single natural language request stated in natural language. This embodiment of the NLDQ application is herein referred to as the “Conceptual Join” (“CJ”) embodiment. Accordingly, FIG. 2 is an exemplary relational block diagram of a cohesive intelligence system known as a conceptual join.

### Conceptual Join as a Network of Taxonomies

The CJ embodiment extends the NLDQ by providing a network of ontology taxonomies that together form a “Cohesive Intelligence System” of shared ontologies. The semantic and concept objects in this network provide the “common concepts” necessary for conceptual joins. The network of ontology taxonomies in the Cohesive Intelligence System is graphically illustrated in FIG. 2.

In FIG. 2 each distributed client system houses its own Intelligence Stack (iStack), with its client-specific ontologies representing the top levels of their individual topologies. In other words, a first healthcare client 210 and a second healthcare client 212 maintain their own ontologies, and similarly a first department of defense (DOD) contractor 214 and a second DOD contractor 216 maintain their own ontologies. However, the healthcare clients 210, 212 share a common general healthcare ontology 220, and the DOD contractors have a common DOD ontology 222. More generalized healthcare ontologies 230 and more generalized DOD ontologies 232 may also exist. The centralized Cohesive Intelligence System (CIS) 250 replicates each distributed iStack's set of ontologies 220, 222, including other ontologies 240 starting with the level just below the client-specific ontology at the top of each iStack taxonomy. More general, yet common, ontologies 260 may form a foundation of the CIS.

### Conceptual Join (CJ) Methods

The invention comprises methods which collectively accomplish a “round trip” sequence of events, starting with the entry and submission by the user of the Natural Language (NL) request together with a list of the target databases to query, and ending with the successful return of an exact answer (sometimes presented as a grid or table on the user's browser).

The CJ methods are both distributed and cohesive: some methods are performed on distributed computer systems, and some methods handle the collection, collating and merging of facts and information contributed by the target disparate databases. On each computer system housing one or more targeted databases, a repository of semantified ontologies exists, wherein the top level of each individual iStack taxonomy is mapped to actual database schema objects representing a target database housed on that computer system.

With this distributed but cohesive system architecture, a single request can be rephrased as a Common NL Request and multicast to multiple disparate data sources, where individual SQL queries can be executed and their result sets merged into a single answer.

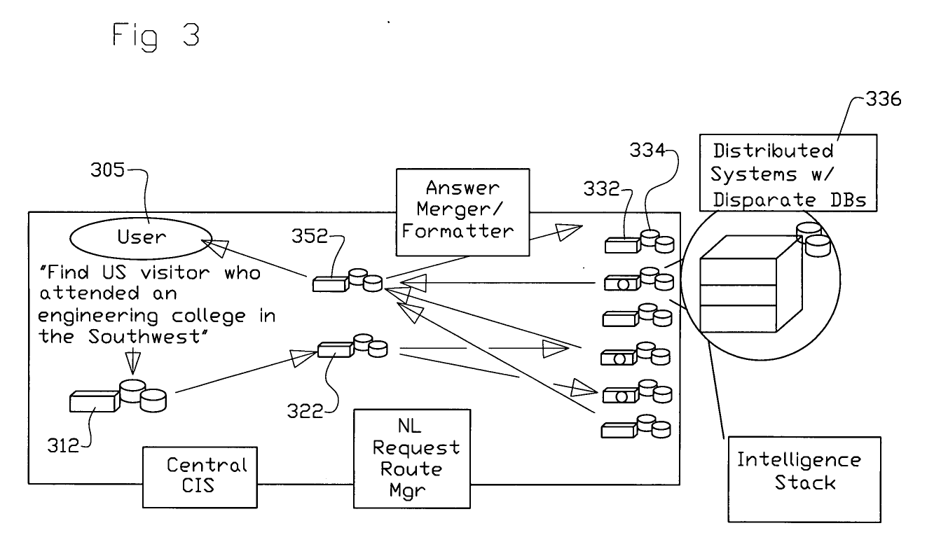

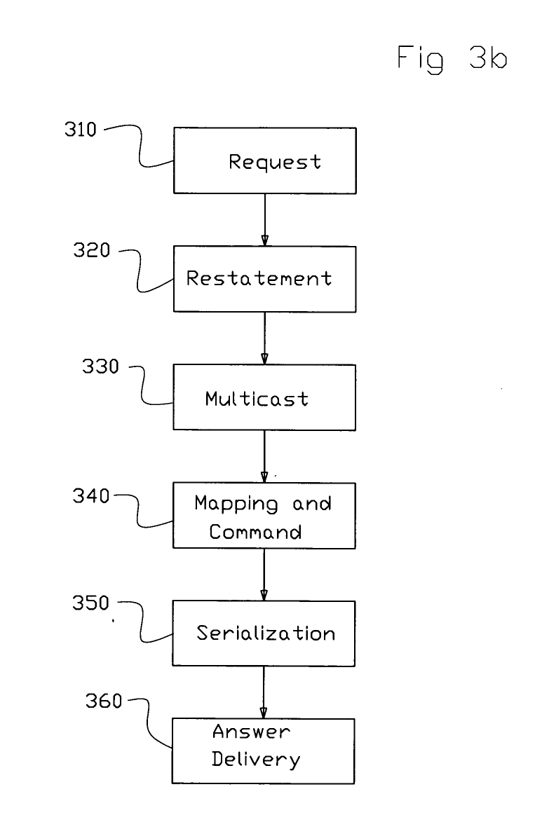

The acts which are accomplished as constituent methods of this round-trip sequence of events are shown in FIG. 3a in a graphic illustration of a single natural language request being answered from facts and information collected from disparate databases. Similarly, FIG. 3b is a block-flow diagram of the method discussed in FIG. 3a.
a) First, in a request act 310, a non-technical Analyst can type in a Natural Language Request (NL Request) in a textbox on a web page in his or her browser. In addition, the user checks one or more (or “all”) of a set of top-level ontologies (those whose concept-model objects are related to target relational databases from which to extract, collate, format and return a composite answer to the requesting user). The NL Request and the list of selected target top-level ontologies are sent to the central Cohesive Intelligence System (CIS) 312.
b) Next, in a restatement act 320, the NL Request is restated internally in semantic phrases found within the CIS 312 to be common to all target disparate databases; this results in a Common NL Request, which is sent to a NL Request Route Manager 322.
c) Then, in a multicasting act 330, the NL Request Route Manager 322 multicasts the Common NL Request to all computer systems 332 housing targeted databases 334.
d) On each computer system 332 housing one or more targeted databases 334, a repository of semantified ontologies exists, wherein the top level of each individual iStack taxonomy is mapped to actual database schema objects representing a target database housed on that computer system. Accordingly, in a mapping and command act 340, for each iStack on a computer system 332, the basic NLDQ methodologies described above are performed and a SQL command is executed on the target database(s) 334.
e) If the distributed system can return a full “answer” or a partial set of facts, the result set objects of the database query are serialized into XML in a serialization act 350 and sent to a Staging System housing the Answer Merger 352, which in an answer merging act merges results generated from the target databases 334 and Answer Formatter 354, which in a formatting act formats the answer(s) for presentation to the user.
f) The methodology terminates with an answer delivery act 360, in which the composite answer is sent back to the requesting user.

### Examples of Specific Methodologies

Answer Merger: Merging Partial Result Sets with Conceptual Join Methods and Algorithms

Merging facts and information from disparate databases to answer a single request involves some specialized methods, compared to returning an answer from a single database. These specialized conceptual join methods and algorithms are preferably enabled by the Answer Merger, and are discussed below:
1. Merging orthogonal partial sets of information gathered from disparate databases.
   As in NLDQ, a “complete answer” is desired. Often, this is possible when extracting facts from disparate databases. The scenario is for the result sets sent from each database to be “orthogonal” (result sets contain the same meaning of columnar data). In this scenario, the common columns are UNIONed to merge the constituent result set rows into a final, complete answer.

### EXAMPLE

### “Count the Employees with Computer Science Degrees, by Department”.

Say there are three target databases selected to answer this request, and say that each target database includes entities and concepts included or implied in the request (“Department”, “Employee”, “Degree”, “Degree Type”). In this case, an orthogonal set of information is collected: each site sends result sets with rows having two columns: a Department Name and a Count (of employees with CS degrees).
The specialized conceptual join algorithm for merging orthogonal facts is to UNION the result sets over the Department column, summing counts where Department Name is the same.
2. Merging non-orthogonal partial sets of information.
   Some types of user requests involve piecing together non-orthogonal partial sets of information extracted from each individual target database.

### EXAMPLE

### “Which Employees with Computer Science Degrees have had more than 2 NSA Clearances”.

Say there are three target databases selected to answer this request, and say that two target databases (A and B) include entities and concepts for “Employee”, “Degree”, “Degree Type”, and the third target database (C) is the National Security Agency Clearance database, containing the concepts “Person”, “Security Clearance Type”, “Clearance Grant”. The result sets gathered from these disparate databases are non-orthogonal, and merging the non-orthogonal result sets requires more sophisticated Conceptual Join algorithms.
   CJ algorithms employed here are:
a) Find common “identity” concepts within the result set objects.

The “Employee Name” result set object type collected from A and B is an Attribute of the Entity “Employee”, which is related by transition (“hypernymy”) to the entity “Person” in the common OntoloNet taxonomy of ontologies.

Names are not reliable sources of determining personal identity. Ideally there are more reliable identity types, common to all data sources, that can be matched (e.g., Social Security Number).

If common identity-type values are returned from the target databases, then a UNION can be performed over the Identity column, but showing only Employee Name/Person Name (for privacy of information reasons).
b) Alternative CJ methods.

If no common identity columns can be found, a Clarification Dialog may be used to prompt the user to invoke a secondary search request to find commonality of result set objects. For example, a search of Employee/Person residence history (perhaps from a target database other than those targeted for the composite answer) may be initiated, and common result set objects from this secondary search can possibly be joined at the concept level by the regular CJ algorithm discussed above and accompanied by FIGS. 3a and 3b.

### Real-Time Enterprise View Embodiment

An embodiment of this invention provides “drill-down” and other real-time functionality to a user (usually a trained Analyst). This embodiment is called the Real-time Enterprise View embodiment.

In this embodiment, a single complete answer may or may not be returned to the user. In either case, the user is shown the number of rows of the facts and information submitted by each targeted database site. The result set objects are maintained at the individual distributed system site. The user can employ different CJ methods, some of which are discussed below, to view facts and information at these distributed sites.
a) Drilldown.
   The user can click on any site and can then see the rows contributed by that site.
b) Selective partial merge.
   The user can “drag” the result set captured at one distributed data source over to another constituent source, and then issue requests for merging facts using the “imported” result set objects with the constituent source result set objects.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method for answering a user information request to a database, stated in natural language, by dynamically retrieving and merging facts and information from disparate databases and presenting an answer to the user, comprising:
a user submitting a Natural Language (NL) request to a Natural Language Understanding (NLU) module, the NLU module interpreting the meaning of the user NL Request as a set of semantic objects within a taxonomy of ontologies;
transforming the semantic objects into mirrored concept objects within the taxonomy;
mapping the mirrored concept objects by inferencing to “top-level” concept objects within the taxonomy that map to database schema objects of constituent databases within a targeted federated database;
mapping the top-level concept objects to an actual database schema objects of a target relational database;
generating a database query command in Structured Query Language (SQL);
executing a database query against at least one targeted database or against a federated database of several databases housed on a common server; and
capturing, formatting and returning the result set of the query to the user.

2. The method of claim 1 wherein the act of generating a database query joins database elements from constituent databases within a federated database.

3. A method for answering a user information request to at least two databases, stated in natural language, by dynamically retrieving and merging facts and information from disparate databases and presenting an answer to the user, comprising:
receiving at a Cohesive Intelligence System (CIS), via a web browser, a Natural Language Request (NLR) which comprises at least one identified ontology;
converting the NLR into semantic phrases identifiable by the CIS, defining a Common NLR;
multicasting the Common NLR to a plurality of computing systems including a first computing system, each computing system comprising at least one targeted database;
at the first computing system, converting the Common NLR to an SQL command;
executing an SQL command on each targeted database associated with the first computing system;
serializing the result set of the database query, the result set comprising results;
merging the results; and
formatting the results for presentation to a user.

4. The method of claim 3 wherein the act of multicasting comprises systems of a second class, each constituent of which houses at least one targeted database.

5. The method of claim 3 further comprising mapping the NLR semantic phrases to concept objects related through inference to actual database schema objects of at least two disparate databases.

6. The method of claim 3 further comprising rephrasing the user's NLR into a Common NLR, replacing phrases related to concept objects in a top-level ontology (one whose concept objects map directly to database schema objects of a target database) with phrases related to concept objects in a “common” ontology.

7. The method of claim 3 further comprising translating any Common NLR phrases to their equivalent phrase in a base language.

8. The method of claim 3 further comprising repeating each act for each additional class of database, if any.

9. The method of claim 3 further comprising at each constituent computing system of the first class, capturing the result set of each SQL command executed against target database(s) housed at that constituent computing system, then serializing the result sets thus captured and forwarding them to a computing system of a second class.

10. The method of claim 3 further comprising, for each class, receiving and logging the source of each serialized result set forwarded by each constituent computing system of the first class; merging the result sets into a single comprehensive result set; and formatting the comprehensive result set for presentation to a user; and returning the formatted results to the user.

11. A system for providing answers to a user information request to at least two databases, stated in natural language, by dynamically retrieving and merging facts and information from disparate databases and presenting an answer to the user, comprising:
an input-output (I/O) device for receiving a user request and displaying a result;
a Cohesive Intelligence System (CIS), that receives a Natural Language Request (NLR) which comprises at least one identified ontology, converts the NLR into semantic phrases identifiable by the CIS, defining a Common NLR, and multicasts the Common NLR;
a plurality of computing systems that receive the Common NLR, including a first type of computing system, each computing system comprising at least one targeted database;
the first constituent computing system of the first type of computing system converting the Common NLR to an SQL command and executing it against one or more targeted databases housed on the first computing system; then forwarding the result sets to a second type of computing system,
one or more disparate and possibly geographically dispersed computing systems of the first type of computing system performing the functions performed on the first constituent computer system;
a separate and second type of computing system that merges and formats the result sets of the SQL commands executed on and forwarded by all of the constituent computer systems of the first type; and returns the results to the user.
